(19) United States
(12) Patent Application Publication
(10) Pub. No.: US 2001/0015299 A1
(43) Pub. Date: Aug. 23, 2001

(54) ENVIRONMENTALLY SENSITIVE HYBRID VEHICLE

(76) Inventor: THOMAS S. MOORE, OXFORD, MI (US)

Correspondence Address: MARK P CALCATERRA CIMS-483-02-19, CHRYSLER CORPORATION, CHRYSLER TECHNOLOGY CENTER, 800 CHRYSLER DRIVE EAST, AUBURN HILLS, MI, 483262757

(21) Appl. No.: 09/118,286

(22) Filed: Jul. 17, 1998

Related U.S. Application Data
(63) Continuation-in-part of application No. 08/380,270, filed on Jan. 30, 1995, now Pat. No. 5,908,077.

(51) Int. Cl. B60K 17/356; B60K 1/00

(52) U.S. Cl. 180/243; 180/65.2; 180/197

(57) ABSTRACT

A hybrid vehicle is provided including an internal combustion engine mounted in a forward portion of the vehicle for driving engagement of a pair of wheels attached to a front axle. An electric motor is mounted in a rear portion of the vehicle for driving engagement of another pair of wheels through a rear axle. A set of batteries for powering the electric motor are stored in the trunk of the vehicle or beneath the trunk floor. A controller is used for controlling the driving engagement of the pair of axles by the electric motor and the internal combustion engine. More particularly, the electric motor is automatically operated to drive the rear wheels when increased horsepower is demanded such as during heavy acceleration or high speed cruising or when enhanced traction is required due to a slip condition.

### CROSS-REFERENCE TO RELATED APPLICATIONS

This application is a continuation-in-part of U.S. application Ser. No. 08/380,270, filed Jan. 30, 1995.

### BACKGROUND OF THE INVENTION

1. Field of the Invention

The present invention relates generally to hybrid vehicles and, more particularly, to an environmentally sensitive hybrid vehicle in which an internal combustion engine drives one pair of wheels and an electric motor drives another pair of wheels.

2. Description of the Related Art

Hybrid vehicles employing internal combustion engines and electric motors to drive the vehicle are well known in the art. Typically, in the past, hybrid vehicles have suffered from being underpowered or have produced unacceptable levels of potentially hazardous emissions during stop and go or intermittent operation such that advantages over single internal combustion engine vehicles have not been significant. Hybrid vehicles which have attempted to merge internal combustion engines and electric motors have also suffered from design deficiencies in the location of these components in the vehicle. Such previous design deficiencies have added to the impracticality of such vehicles. Thus, there is a need in the art to provide a hybrid vehicle which effectively packages the necessary power components of the vehicle and selectively applies power from the electric motor to supplement horsepower and tractive demands.

### SUMMARY OF THE INVENTION

It is, therefore, one object of the present invention to provide an environmentally sensitive hybrid vehicle.

It is another object of the present invention to provide a hybrid vehicle which employs an internal combustion engine to drive one pair of wheels and an electric motor to drive another pair of wheels.

It is yet another object of the present invention to only applied power from the electric motor when increased horsepower or additional traction is required.

To achieve the foregoing objects, the present invention is a hybrid vehicle including a vehicle frame having a pair of rails disposed in spaced relation relative to each other and defining a longitudinal axis of the vehicle. The hybrid vehicle also includes a pair of axles spaced longitudinally from one another and extending substantially transverse to the longitudinal axis of the vehicle. On each axle is a pair of wheels operatively mounted thereto for rolling engagement with a surface. The hybrid vehicle includes an internal combustion engine mounted for driving engagement of one pair of the wheels through one of the axles and an electric motor mounted for driving engagement of the other pair of wheels through the other axle. The hybrid vehicle's electronic control unit monitors engine operation to determine when the vehicle is experiencing extreme acceleration or is approaching top speed. Thereafter, the electronic control unit activates the electric motor which applies additional power to the vehicle to boost horsepower. The electronic control unit also monitors the wheels in driving engagement with the internal combustion engine for slippage. When a slip condition is detected, the electronic control unit activates the electric motor which applies power to the other pair of wheels to enhance tractive engagement with the road surface.

One advantage of the present invention is that an environmentally sensitive hybrid vehicle is provided. Another advantage of the present invention is that the hybrid vehicle employs an internal combustion engine to drive one pair of wheels and an electric motor to drive another pair of wheels. Yet another advantage of the present invention is that the hybrid vehicle normally operates with the internal combustion engine alone and only selectively applies power from the electric motor. In this way, the hybrid vehicle is powered during steady state operation by the internal combustion engine thus reducing fuel consumption relative to larger horsepower generating internal combustion engines. Still another advantage of the present invention is that the hybrid vehicle, during periods of acceleration or under increased tractive requirements, is provided with an electric motor engaged to drive the other pair of wheels through the other axle. A further advantage of the present invention is that the hybrid vehicle includes all the advantages of gasoline powered engines while still maintaining design freedom such that a commercially viable vehicle may be produced.

Other objects, features and advantages of the present invention will be readily appreciated as the same becomes better understood after reading the subsequent description when considered in connection with the accompanying drawings.

### BRIEF DESCRIPTION OF THE DRAWINGS

FIG. 1 is a fragmentary elevational view of a hybrid vehicle, according to the present invention;

FIG. 2 is a plan view of the hybrid vehicle of FIG. 1.

### DESCRIPTION OF THE PREFERRED EMBODIMENTS

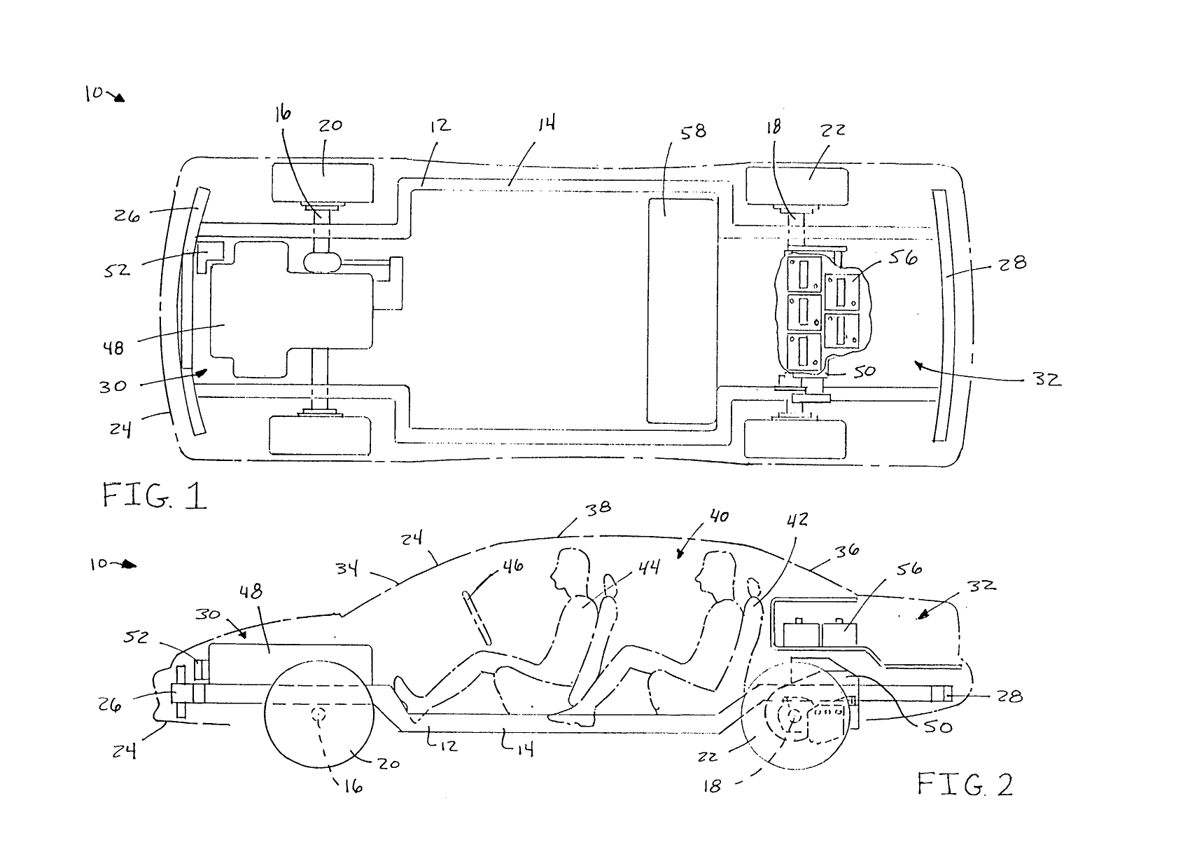

Referring to FIGS. 1 and 2, a hybrid vehicle, according to the present invention, is generally shown at 10. Although the present invention is particularly well suited for use in 4×4 type vehicles such as that illustrated, it may also be employed in other types of vehicles such as passenger cars. The vehicle 10 includes a vehicle frame, generally indicated at 12, having a pair of rails 14 disposed in spaced relationship relative to one another and defining a longitudinal axis of the vehicle 10. The vehicle 10 also includes a front axle 16 and a rear axle 18 disposed spaced from one another and extending substantially transverse to the longitudinal axis of the vehicle 10. The front axle 16 and rear axle 18 are operatively connected to the rails 14 as is known in the art. The front axle 16 includes a pair of front wheels 20 and the rear axle 18 includes a pair of rear wheels 22. Both front and rear wheels 20, 22, respectively, are operatively mounted to their respective axles for rolling engagement with a surface such as a road as is known in the art.

The vehicle 10 includes a vehicle body, generally indicated at 24, which is supported upon the vehicle frame 12. The vehicle body 24 may have many of the components typically associated with automotive vehicles but it is to be understood that the vehicle body 24 may be styled in any way contemplated by the designer and the following discussion of certain common components of the vehicle body 24 is by way of description only and not by way of limitation. More specifically, the vehicle body 24 may include a front bumper 26 and a rear bumper 28 attached to the rails 14 and a forward storage compartment 30 and rear storage compartment 32. The vehicle body 24 may include a windshield 34, rear window 36 and roof line 38 as commonly known in the art. The vehicle body 24 defines an occupant compartment 40 having any number of sears 42 so as to accommodate occupants 44. The vehicle body 24 includes a steering wheel assembly 46 in the forward portion of the occupant compartment 40 to steer the vehicle 10 as is commonly known in the art.

The vehicle 10 further includes an internal combustion engine 48 mounted for driving engagement of the front wheels 20 through the front axle 16. The engine 48 is mounted along the longitudinal axis of the vehicle 10 and is supported by the rails 14 as is known in the art. The internal combustion engine 48 is preferably of the four or six cylinder type adapted for burning a fuel such as gasoline or diesel. The four or six cylinder internal combustion engine 48 has better fuel economy than conventional eight cylinder gasoline or diesel engines. In the preferred embodiment, the internal combustion engine 48 has a 3.5 liter capacity which generates 253 horsepower. Further, the vehicle 10 employs a conventional or computer shifted manual transmission 49 to transfer power from the internal combustion engine 48 to the front axle 16. Thus, the internal combustion engine 48 of the present invention is sufficient to cruise up to a substantial speed with a minimized coefficient of drag in the frontal area of the vehicle 10 and rolling resistance. It should be appreciated that other suitable types of internal combustion engines and fuel may be used.

The vehicle 10 also includes an electric motor 50 mounted for driving engagement of the rear wheels 22 through the rear axle 18. The vehicle 10 includes a controller 52 disposed forward of the front axle 16 and below the forward storage compartment 30. The controller 52 operates to control the driving engagement of the front axle 16 and rear axle 18 by the electric motor 50 as well as the engine 48. The vehicle 10 also includes a set of batteries, generally indicated at 56, mounted or housed within the rear storage compartment 32 or trunk of the vehicle body 24 and transverse to the longitudinal axis of the vehicle 10. More specifically, the set of batteries 56 may be disposed aft of the rear axle 18 and equidistant between the rails 14 of the vehicle frame 12 as illustrated, for example, in FIG. 1. In the preferred embodiment, the set of batteries 56 include five (5) power cells or batteries of the bi-polar, deep cycle acid type and provide an electrical power source for the electrical motor 50. While five (5) batteries are shown in the figures, the set of batteries 56 may include any number of individual batteries or power cells and the specific number is dictated by other design parameters not pertinent to the present invention. Alternatively, the batteries 56 may be stored under the floor of the vehicle 10. In addition, the vehicle 10 includes a fuel tank 58 disposed slightly in front of the rear axle 18 and parallel to the set of batteries 56. The fuel tank 58 may be of any capacity but a twenty (20) gallon tank is contemplated by the vehicle 10 of the present invention. If desired, the location of the fuel tank 58 and batteries 56 may be reversed from that illustrated.

In its operative mode, the internal combustion engine 48 may be disconnected during braking of the vehicle 10. The controller 52 then signals the electric motor 50 such that it engages to operate as a generator during deceleration to recharge the batteries 56. Thus, the electric motor 50 also acts as a brake, slowing the vehicle 10 during periods when deceleration is required.

The vehicle 10 is powered during steady state operation by the internal combustion engine 48 alone, thus providing sufficient horsepower and traction via front wheels 20 for normal operation and also maintaining excellent fuel efficiency. During periods of heavy acceleration, high speeds or under increased tractive requirements (i.e., when the front wheels 20 slip), the electrically powered motor 50 is engaged to drive the rear pair of wheels 22 through the rear axle 18 to increase horsepower and to enhance tractive engagement with the road surface. More specifically, the present invention uses a four or six cylinder engine 48 rather thana a V8 to achieve better fuel economy. However, for greater performance (0-60, etc.) such as that common with V8 engines, the electric motor 50 is employed. Further, the present invention provides a four wheel drive traction platform on slippery surfaces. When the vehicle ABS/traction control system senses rear wheel slip, the controller 52 supplies power to the front wheels 20 via the electric motor 50 to add front wheel drive traction. This provides an “on demand” four wheel drive feature automatically without the driver shifting or doing anything. The batteries 56 necessary for powering the electric motor 50 are stored in the rear storage compartment 32 or trunk of the vehicle 10. More specifically, the batteries 56 are disposed transverse to the longitudinal axis of the vehicle 10 and equidistant between the rails 14 of the vehicle frame 12. The vehicle 10 of the present invention thus solves a particular problem in conventional hybrid vehicles with the arrangement and relative duties of the necessary components of a hybrid vehicle with surprising unanticipated results.

The present invention has been described in an illustrative manner. It is to be understood that the terminology which has been used is intended to be in the nature of words of description rather than of limitation.

Many modifications and variations of the present invention ar possible in light of the above teachings. Therefore, within the scope of the appended claims, the present invention may be practiced otherwise than as specifically described.

What is claimed is:

1. A hybrid vehicle comprising:
a vehicle frame having a pair of rails disposed in spaced relation relative to each other and defining a longitudinal axis of the vehicle, a pair of axles spaced longitudinally from on another and extending substantially transverse to said longitudinal axis, each with a pair of wheels operatively mounted thereto for rolling engagement with a surface;
an internal combustion engine mounted for driving engagement of one pair of said wheels through one of said axles and an electric motor mounted for driving engagement of the said other pair of wheels through said other axle;
a controller coupled to said electric motor for selectively actuating said electric motor for driving said other pair of wheels during periods of increased horsepower and tractive demands.

2. A hybrid vehicle as set forth in claim 1 further comprising:
a set of batteries disposed transverse to said longitudinal axis of said vehicle and in a rear storage compartment of said vehicle for providing an electrical power source to said electric motor.

3. A hybrid vehicle as set forth in claim 1 further comprising a set of batteries disposed substantially equidistant between said pair of rails of said vehicle frame and aft of a rear one of said pair of axles.

4. A hybrid vehicle as set forth in claim 1 including a front drive shaft disposed parallel to said longitudinal axis of said vehicle interengaging a front one of a pair of axles and said electric motor.

5. A hybrid vehicle as set forth in claim 4 wherein said fuel tank is disposed parallel to and opposite a set of batteries serving as a power source for said electric motor.

6. A hybrid vehicle as set forth in claim 1 wherein said internal combustion engine is disconnected during braking of said vehicle and said electric motor is engaged to operate as a generator during deceleration to recharge a set of batteries.

7. A hybrid vehicle as set forth in claim 1 wherein said internal combustion engine is a six cylinder engine adapted for burning gasoline.

8. A hybrid vehicle as set forth in claim 7 wherein said axle driven by said engine is a front axle of said vehicle and said axle driven by said electric motor is a rear axle of said vehicle.

9. A hybrid vehicle as set forth in claim 8 wherein said electric motor is mounted slightly behind said rear axle.

10. A hybrid vehicle as set forth in claim 9 wherein said controller is disposed forward of said front axle and operates to control the driving engagement of said rear axle by said electric motor when said wheels mounted to said front axle slip or said internal combustion engine experiences heavy acceleration.

11. A hybrid vehicle comprising:
a vehicle frame having a pair of rails disposed in spaced relationship relative to one another and defining a longitudinal axis of said vehicle, a front axle and a rear axle spaced longitudinally from one another and extending substantially transverse to said longitudinal axis of said vehicle, each of said front and rear axles including a pair of wheels operatively mounted thereto for rolling engagement with a surface;
an internal combustion engine mounted for driving engagement of said pair of wheels mounted to said front axle and an electric motor mounted for driving engagement of said pair of wheels mounted to said rear axle; and
a controller operatively connected to said internal combustion engine and said electric motor for determining when said wheels mounted to said rear axle slip and activating said electric motor to drive said wheels mounted on said front axle in response thereto.

12. A hybrid vehicle as set forth in claim 11 further comprising:
a set of batteries disposed transverse to said longitudinal axis of said vehicle and within a rear storage compartment of said vehicle for providing an electrical power source to said electrical motor.

13. A hybrid vehicle as set forth in claim 11 further comprising a set of batteries disposed substantially equidistant between said pair of rails of said vehicle frame and aft of said rear axle.

14. A hybrid vehicle as set forth in claim 11 including a fuel tank disposed between said rails between said internal combustion engine and said electric motor.

15. A hybrid vehicle as set forth in claim 14 wherein said fuel tank is disposed parallel to and opposite a set of batteries serving as a power source for said electric motor.

16. A hybrid vehicle as set forth in claim 11 wherein said controller is disposed forward of said front axle and operates to determine when increased horsepower is required and activates said electric motor to drive said wheels mounted on said rear axle in response thereto.

17. A hybrid vehicle comprising:
a vehicle frame having a pair of rails disposed in spaced relation relative to each other and defining a longitudinal axis of the vehicle, a front axle and a rear axle spaced longitudinally from one another and extending substantially transverse to said longitudinal axis, each of said front and rear axles having a pair of wheels operatively mounted thereto for rolling engagement with a surface;
an internal combustion engine mounted for driving engagement of said pair of wheels mounted to said front axle and an electric motor mounted for driving engagement of said wheels mounted to said front axle; and
a controller operatively connected to said internal combustion engine and said electric motor for determining when increased horsepower is required and activating said electric motor to drive said wheels mounted on said front axle in response thereto.

18. A hybrid vehicle as set forth in claim 19 further comprising a set of batteries housed within a rear storage compartment of said vehicle body and disposed transverse to said longitudinal axis of said vehicle aft of said rear axle for providing an electric power source to said electric motor.

19. A hybrid vehicle as set forth in claim 17 including a fuel tank disposed between said rails and also between said internal combustion engine and said electric motor.

20. A hybrid vehicle as set forth in claim 19 wherein said fuel tank is disposed parallel to and opposite a set of batteries servicing as a power source for said electric motor.

21. A hybrid vehicle as set forth in claim 17 wherein said internal combustion engine is disconnected during braking of said vehicle and said electric motor is engaged to operate as a generator during deceleration to recharge a set of batteries.

22. A hybrid vehicle as set forth in claim 17 wherein said controller is disposed forward of said front axle and operates to determine when said wheels mounted on said rear axle slip and activate said electric motor to drive said wheels mounted on said rear axle in response thereto.
